(19) United States
(12) Patent Application Publication
(10) Pub. No.: US 2010/0000901 A1
(43) Pub. Date: Jan. 7, 2010

(54) Plastic Packaging, Particularly Flexible Tubes, Containing Reactive Substances Associated With A Presence Indicator

(75) Inventors: Alain Jupin, Sainte-Menehould (FR); Michel Bosshardt, Sainte-Menehould (FR)

Correspondence Address: DENNISON, SCHULTZ & MACDONALD, 1727 KING STREET, SUITE 105, ALEXANDRIA, VA, 22314, US

(73) Assignee: CEBAL SAS, Gennevilliers (FR)

(21) Appl. No.: 11/722,440

(22) PCT Filed: Jan. 6, 2006
(86) PCT No.: PCT/FR2006/000024

§ 371 Date: Jun. 21, 2007

(30) Foreign Application Priority Data
Jan. 10, 2005 (FR) 0500214

(51) Int. Cl. B65D 85/00; A01N 59/16; B29C 45/00; C08J 5/00; A01P 1/00

(52) U.S. Cl. 206/524.4; 206/524.6; 424/618; 264/328.17; 264/331.11

(57) ABSTRACT

A packaging component, having a wall including a layer for direct contact with a product contained within the packaging, said layer formed of an organic polymer having disposed therein 1) a first material reactive with at least one component of the product contained within the packaging or with a physical or chemical contaminant thereof, and 2) a second component in the form of particles which perturb or emit, naturally or under the influence of an artificial source of excitation, a physical field which is remotely detectable and which confirms that the first material is also present. The reactive substance is typically a substance having a biocidal effect, an organoleptic additive, an oxygen-absorbing agent, an emitter of carbon dioxide or sulfur dioxide, a humidity absorber, an antioxidant or a UV filter, and the physically active particles are typically ferromagnetic, x-ray absorbent, an MRI contrast agent, luminescent or thermochromic.

### TECHNICAL FIELD

This invention relates to containers made of plastic material designed to package pharmaceutical, cosmetic and food products. The invention relates most particularly to flexible tubes made of plastic material for cosmetic products.

### STATE OF THE ART

Usually, containers designed for the packaging of such products are flexible tubes, bottles or cases. They are either metallic, metalloplastic or entirely plastic. In the last case, they comprise in general several layers made of different plastic materials, which makes it possible, by combining certain physical, chemical or physicochemical properties, to obtain the desired characteristics in the field of mechanical resistance, of resistance to ultraviolet light and of various constraints connected with tightness (risk of product loss, risk of fragrance loss, risk of oxidation of the packaged product, etc.).

When they are metallic, they are in general made of steel, typically a low carbon steel or, in particular, when flexible tubes are involved, made of aluminium alloy, typically 1050. The inside of the container is most often protected by varnish.

When plastic, they may have a wall made of a single material or, like the metalloplastics, comprise a multilayer wall with internal and external layers made of polyolefin—typically polyethylene or polypropylene—or made of polyester. They possess in general an intermediate layer made of metal or of a plastic material having a barrier effect on the diffusion of gases or flavours, typically a copolymer (ethylene-vinyl alcohol) (EVOH).

In spite of the care brought to bear on the manufacturing of these containers, it is difficult to work under perfect conditions of asepsis, and it can happen, during storage before filling or during filling or at a later stage, that bacteria might penetrate to the inside and then develop on contact with the product contained. Such a development degrades the product and may render it unsuitable for use. In order to avoid these accidents, sterilisation of containers and filling devices is not always sufficient.

A solution consists in incorporating bactericidal substances into the products themselves, but the concentration required for their action to be efficacious may appreciably increase the price of the packaged product or modify its organoleptic properties in an unfavourable manner.

Another solution consists in incorporating bactericidal substances in the structure of the packaging, either on the inner wall, or within the thickness of the container. Such “active” packaging—in the sense that they can react with certain components of the products that they are intended to contain—are currently authorized but subject to often restrictive regulations in particular as concerns the packaging of food products, like Regulation CE No. 1935/2004 of the European Parliament and the European Council of 27 Oct. 2004.

Even if these regulations relate only to food products, it can reasonably be expected that restrictions of the same nature should also be imposed on packaging for pharmaceutical products and cosmetic products.

Among these restrictions, this is found: “The traceability of materials and objects intended to enter into contact with the foodstuffs should be ensured at all stages in order to facilitate monitoring, removal of defective products from the market, informing of consumers as well as the assignment of responsibility.” (article 18 of the Regulation).

In several previous patent applications, the applicant has endowed the container itself with characteristics making it possible for it to play, in addition to its passive role as barrier against attacks coming from the outside, an active role on the contained product itself, such as antioxidant, antiseptic, antifungal or bactericidal, i.e. inhibiting the growth, even destroying micro-organisms that could potentially be present or have been introduced at the time of filling or at any other time, for example during use of the product by the consumer. The “active” role of the packaging may also consist in transmitting flavourings to the packaged product, in absorbing oxygen contained in the ambient atmosphere of the packaged product, in emitting gases such as carbon dioxide and sulphuric anhydride, in having anti-oxidant action, in absorbing oxygen or carbon dioxide, in filtering or absorbing UV rays capable of reaching the product, etc. In the following we will designate all additives capable of fulfilling these functions under the generic term of “reactive substance.”

The active role of the packaging involves an action, by the material contained within the wall of the packaging, inside the volume delimited by the packaging, directly on the contained product or on possible contaminating agents that degrade the quality of said product: oxygen, air, bacteria, UV rays, etc. The concept of active packaging therefore does not include packaging such as that disclosed by U.S. Pat. No. 5,851,611 (multi-layer comprising a barrier layer against diffusion of gases whose decomposition—and therefore the drop in effectiveness—is revealed by dyeing said multilayer) or that disclosed by GB 0 967 171 (packaging comprising on its outer wall a filter treated in such a way as to be able to sterilise the air that crosses it).

Within the context of the mass production of packaging such as flexible tubes, it still does not seem economically profitable to introduce the reactive substance in the form of molecules that are grafted onto the plastic material of the inner wall of the tube. It is preferable to introduce the substance either into the mass of at least one of the constitutive materials of the tube wall, more preferably the one intended to be in contact with the packaged product, or into a varnish which is deposited on the inner wall of said tube. Thus, in the French patent application FR 2 817 242, the applicant described containers, in particular flexible tubes with a distribution orifice and a wall equipped, at least partially, with an inner layer designed to be directly in contact with the product contained by the tube and being made up of an organic material containing a bactericidal substance. In the French patent application FR 2 825 689, the applicant described a metallic tube which comprises a skirt with an open end, the inside surface of said skirt being covered, in proximity to said open end, with an annular adhesive joint, wherein said adhesive joint comprises an oxygen scavenger which is released during final sealing of the tube.

Within the context of the regulations on the packaging of food products, the systematic follow-up of the materials and products used is the subject of a procedure which is expressed by the systematic placing of identification cards on the boxes or palettes which consolidate all or part of the same manufacturing batch. These cards indicate in particular the order number and the references of the materials entering into the composition of the packaging manufactured in this way. If this procedure makes it possible to monitor the origin of products and materials employed, it may turn out to be insufficient in the case of a perturbation on the production line, in particular when the reactive substance introduced into the packaging is a product which reacts only on direct contact with the product, indeed only on possible contact with contaminating agents. In such a case, the only means for ensuring the presence of the reactive substance in the packaging wall is to make, on representative samples of manufacturing batches, tests with contaminating agents such as bacteria. Now, these tests require that cultures be undertaken for long periods of time, typically 8 days, and often more than 15 days. If the results of these tests show insufficient hygiene protection or a degradation of the organoleptic properties of the product, the economic consequences can be serious, since the time interval transpiring between manufacturing and the test results is such that entire manufacturing runs of tubes are at risk of being scrapped, downgraded, or worse, if they have already been delivered to the packager, be the subject of returns, indeed of indemnification for tubes filled, delivered and sold.

The applicant has therefore sought a means making it possible to rapidly recognize, if possible on the production line, the tubes which are able to be packaged and protect products sensitive to biological contamination. By extension, the applicant has assigned herself the task of finding a means that makes it possible to rapidly verify, if possible on the production line, that the manufactured packaging is actually an “active packaging.”

### DESCRIPTION OF THE INVENTION

A first object according to the invention is a packaging component, comprising a wall comprising a layer designed to be directly in contact with the product contained by the packaging, said layer being made of an organic material comprising a reactive substance reacting, inside the volume delimited by said packaging, with at least one component of the packaged product or a contaminating agent that contaminates said product, wherein said wall also comprises an organic material charged with physically active particles, i.e. which are made of a material which perturbs or emits, naturally or under the effect of an artificial excitation source, a physical field such as an electric field, a magnetic field, an electromagnetic field or a beam of electrically charged particles.

Said reactive substance is contained within the wall of the packaging and acts inside the volume delimited by said packaging, either directly with the packaged product (or at least one component of it), or with a contaminating agent which is introduced into said volume: air, oxygen, bacteria, UV rays, etc. More preferably, said reactive substance is a substance which acts through direct contact with said component or contaminating agent, typically for prophylactic purposes or for purposes of preservation of the organoleptic properties of the packaged product. This can be a substance which exerts, for example by chemical reaction, a biocidal action against bacteria. But this may also be an organoleptic additive, a fragrance or a flavour, an oxygen scavenger, a carbon dioxide absorbing agent, a moisture absorbing agent, a UV radiation absorbing agent, an emitter of CO₂, SO₂ or ethanol, an antioxidant or a UV radiation filtering substance. More preferably, this reactive substance is an organic material.

Said wall according to the invention also comprises an organic material wherein have been introduced the different particles of the molecules making up said organic material and which are physically active, in the sense that they can fulfil one of the following functions:

they are irradiating, for example radioactive;

they are luminescent, emitting visible light under the action of physical factors such as the reception of ultraviolet or other radiation;

they change colour under the influence, for example, of heat (thermochromic particles);

they perturb electric, magnetic, electromagnetic, electronic or ionic fields which are emitted by artificial sources, i.e. physical fields other than, for example, sunlight or the terrestrial magnetic field.

The basic idea is to combine the reactive substance with a discrete but easily detectable tracer, more preferably on the production line, for example an optical brightening agent, a thermochromic material, a radioactive element, a ferromagnetic particle, a particle absorbing X-rays or an MRI contrast product.

In order to facilitate traceability, it is recommended to combine the reactive substance and the tracer in the same organic material layer of the wall of the container. If a layer of varnish is involved, the reactive substance and the tracer are added together in the varnish before depositing the latter on the wall of the packaging item. If a plastic material layer is involved, the reactive substance, the tracer and the granules of thermoplastic material are mixed before constructing the wall of the packaging component concerned.

We could certainly combine a single colour in the presence of the reactive substance but this would impose a certain monotony on all packaging provided with said reactive substances and would limit the choice of colours for all other types of packaging. The applicant has therefore preferred to choose a discrete tracer which emits radiation not visible to the naked eye or which perturbs a physical field crossing the packaging. Typically, this may involve a radioactive product, in a small amount but which is sufficient to be detected by an appropriate sensitive monitor, or a tracer which, coloured or otherwise, cannot reveal its function as an indicator of the presence of the reactive substance unless it is triggered by a physical field of artificial origin, namely a field other than, for example, sunlight or the terrestrial magnetic field. Thus, the optical brightening agent does not reveal its presence unless it is excited under ultraviolet illumination, the thermochromic pigment does not become coloured unless it is subjected to a given heat flux, the X-ray absorbent product does not reveal its presence except by passing through a beam of X-rays, or the ferromagnetic product does not reveal its presence except by passing into a magnetic field set up between an emitter and a monitor and by perturbing the latter.

The packaging component may be the container itself, or a part of it, for example, a skirt or a head of a flexible tube, or any other part of the packaging with the role of entering, partially or over the totality of its wall, into contact with the product. As the contact surface between the inner wall of the container and the packaged product is limited, it can in fact turn out advantageously to also treat the accessories associated with the packaging, for example, the stoppering system, —simple stoppers or hinged lid caps, or the inserts introduced into the internal volume of the container, for example, a device introduced into the neck of the container and fitted with an anti-backflow valve, such as that described in application FR 2 828 679, or coverings, typically unwoven, or flexible grilles, introduced inside the volume of the container in order to increase the exchange surface between the reactive substance and the product. As for the container, the reactive substance may be found in the mass of the accessory or only on a superficial layer designed to enter into contact with the product. If it is a matter of a stoppering system, it is possible to treat only the part which is found opposite the distribution orifice when this is stoppered.

In the context of this invention, the container, parts of the container, stoppering system and internal accessories are grouped together under the general term “packaging component.”

More preferably, in order to facilitate the traceability of the components making up the packaging, the reactive substance and the tracer are mixed and intimately linked before manufacture of the structural component of the component designed to receive the reactive substance. This mixture could in fact be carried out directly on the line but the presence of the tracer would not necessarily reveal that of the reactive substance, which would require a supplementary monitoring on the line. If the material making up the layer intended to contain the reactive substance is already treated with the tracer, the follow-up is much simpler: it is possible to monitor the reactive activity of this material also comprising the tracer outside the production line, without the constraint of the short response time indicated above, the on-line monitoring being done only on the proper feeding of this constituent material, for example, by monitoring the presence of the tracer on the layer of the wall of the container during manufacture. The on-line monitoring presents the enormous advantage of ensuring that 100% of the containers are monitored.

Quite obviously, a specific tracer can be combined with a given reactive substance. The choice of tracers being probably limited by restrictive conditions of compatibility between the tracer and the product to be packaged, the reactive substance, and the other constitutive materials of the container, it can turn out to be advantageous to combine the tracers, isolated or as a mixture, with the various reactive substances contemplated: optical brightening agent combined with reactive substance 1; thermochromic material combined with reactive substance 2; ferromagnetic particles combined with reactive substance 3; optical brightening agent+thermochromic material combined with reactive substance 4, etc.

More preferably, therefore, we prepare the constitutive raw material of the layer that is to comprise a reactive substance by adding this and the tracer to said raw material. For example, the reactive substance and the tracer are mixed in the varnish before deposit of the latter on the concerned part of the packaging component. Or if it is a matter of reactive substance introduced into the mass, a masterbatch is created containing said reactive substance and said tracer before its mixture with the plastic material making up the packaging component to be constructed.

The monitoring of the presence of the reactive substance in the masterbatch or the varnish can be done by standard method with long-term tests since it is performed outside the production line. More rapid chemical methods can also be used for some of them; silver salts are characterised by precipitation of silver chloride; copper salts are characterised by formation of an intense blue complex with the copper II tetramine ion, sodium benzoate is characterised by absorption at 589/589.6 nm and chitosan is characterised by measuring its acetyl content by assaying the relative proportions of N-acetyl glucosamine and glucosamine by infrared spectrometry.

The monitoring of the presence of the tracer may be carried out as much on the raw material as on the packaging component during manufacture. For example, if the packaging component is a skirt of flexible tube, constructed by cutting along the length of an extruded plastic sleeve, we introduce the masterbatch containing the reactive substance and the tracer in the form of granules that are poured as an additive into the hopper feeding the extruder of granules of thermoplastic material. The presence of the tracer is monitored in the granules of the masterbatch used as additive and on the surface of the extrudate coming out of the die. If an additive feed problem appears, monitoring of the extrudate coming out of the die makes it possible to very rapidly detect the appearance of the manufacturing incident and to make the required corrections immediately after.

The reactive substance is chosen as a function of the use aimed at. This can be an ethanol releasing agent, an oxygen absorber, a CO₂ and/or SO₂ emitter, a moisture absorbent, an antioxidant, a UV filter, a substance with a biocidal action such as one of the following products: nitrites, sulfites, organic acids, antimicrobials of natural origin such as extracts—more preferably deodorised—of cypress, citrus fruits, sweet basil, pepper, mustard, wasabi or chitosan—obtained from the carapaces of crustaceans or insects by deacetylation of chitin—, butyl hydroxy-toluene (BHT), methyl parahydroxybenzoate, ethyl parahydroxybenzoate, potassium sorbate, benzoic anhydride, sorbic anhydride, sodium benzoate, triclosan (chloro-5 [dichloro-2.4-phenoxy]-2 pheno), quaternary ammonium salts such as dodecyl dimethyl benzylammonium chloride, salts of metallic silver and/or copper ions, possibly combined with zinc oxide and fixed, for example, on a microporous absorbent structure of the zeolith type.

The reactive substance is incorporated with the tracer in the varnish or in a thermoplastic material serving as a base for a masterbatch, typically a polyethylene. In the first case, the reactive substance and the tracer, advantageously in the form of fine solid particles, are poured and mixed directly in the varnish. In the second case, the reactive substance and the tracer, advantageously in the form of powders, must be able to withstand being brought to the melting temperature of the thermoplastic material without losing their ability to fulfil the function which is assigned to them. A certain number of the agents cited above can withstand temperatures greater than 120° C. and are therefore extruded or injected with, for example, a polyolefin, typically polyethylene or polypropylene.

The tracer may be a radioactive body such as phosphorus 32 or, for certain applications intended for use in monitored media, tritium. The quantity must be as low as possible and, in general, a few ppb (parts per billion) is sufficient to be detected.

The X-ray absorbing particles can be products of high molecular mass, such as heavy metals such as lead, but these are generally interdicted for recycling and environmental reasons. A radiological product such as barium sulphate can be used.

The materials perturbing the magnetic or electromagnetic field are, for example, ferromagnetic products, such as iron, nickel, cobalt, gadolinium and certain of their alloys, or ferromagnetic oxides such as magnetite or the ferrites. They are presented more preferably in the form of powders, flakes or filings that can be mixed with the reactive substance and a thermoplastic material to create a masterbatch. They are, however, in general not colourless and their use runs the risk of greatly limiting the choice of colours, which is a disadvantage for packaging.

In a general way, if the tracer is not colourless and if it is introduced into a wall of the packaging component which is visible from the outside, it is preferable to choose, for this wall, a dark colour or to deposit an external layer of lacquer so as to not disclose the presence of the tracer. If a container with a multilayered wall is involved, the tracer—and the reactive substance—may also be introduced only into the inner layer of the container. However, an advantage can be found in having the visible outer surface of the wall also active, i.e. provided with reactive substance, in particular a biocide, in order to prevent the risk of contamination during the various manipulations of the packaging.

More preferably, on account of their ease of use, a fluorescent pigment or a thermochromic pigment is chosen as a tracer.

The fluorescent pigment is, for example, an optical brightening agent excitable under ultraviolet illumination, such as 2.5-thiophenediyl-bis-(5-tert-butyl-1.3-benzoxazole). The UV illumination device is easy to set up. It may be placed, for example, in such a way that it illuminates the extrudate coming out of the extrusion die or the moulded piece at the time this is unmoulded. A camera set up in order to visualize the radiation emitted by the surface of the exudates or the moulded piece makes it possible, by visual monitoring or by automatic monitoring, to detect all anomalies.

The thermochromic pigment is more preferably selected from micro-encapsulated leucoderivatives. More preferably, a reversible thermochromic pigment is chosen, colourless below a certain temperature, typically 60° C.-80° C. As for the optical brightening agent, a camera installed in order to view the surface of the extrudate or of the moulded part makes it possible, by visual monitoring or by automatic monitoring, to detect all anomalies.

As far as the flexible laminated tubes are concerned, the skirt of which is obtained by rolling of a band and then thermal welding of the edges of the band after these have been put opposite each other, such a device may also reveal its usefulness when the band is multilayered, in order to verify that the outer layer of the band which becomes the inner layer of the cylinder after rolling is actually that containing the reactive substance.

### EXAMPLES

### Example 1

### Production of a Bactericidal Masterbatch with Tracer

The bactericidal agent is a silver salt in an inert support of zeolith, combined with a zinc oxide. It is marketed under the name IRGAGUARD (registered trademark) B5000 by the CIBA GEIGY company.

This bactericidal agent which is presented in the powder form is mixed with granules of thermoplastic material and an optical brightening agent powder marketed under the UVITEX OB brand (registered trademark) by the CIBA GEIGY company and has the following chemical formula: 2.5-thiophenediyl-bis-(5-tert-butyl-1.3-benzoxazole). The mixture is carried out in the proportions of, respectively, approximately 20% by weight for the bactericide, approximately 80% by weight of thermoplastic material and less than 0.5% for the optical brightening agent, here typically 0.01%. The plastic material is chosen as a function of the subsequent use. This may be a polyolefin, for example, a low density polyethylene (LDPE), a high density polyethylene (HDPE) or a polypropylene (PP).

Each component of the mixture is put into a hopper which feeds the end of an extruder with two screws. The mixing of the powders, the melting of the thermoplastic and the mixing of the constituents in the molten thermoplastic are carried out during passage of the material in the flow channels of the extruder. The extrusion is carried out at a temperature between 120° C. and 200° C. The product is extruded in the form of a multitude of thin filaments which are cut up by means of knives as they come out of the die in such a way as to create the granules of the masterbatch.

### Example 2

### Extrusion of a Low Density Polyethylene Cylindrical Sleeve Containing a Bactericide with Tracer

Low density polyethylene (LDPE) granules and granules of a masterbatch with a LDPE base, produced according to example 1, are mixed in the proportions, respectively, of approximately 2% by weight for the masterbatch and approximately 98% by weight of LDPE.

Each component of the mixture is put in a hopper which feeds the end of a screw-type extrusion machine. The mixing of the powders, the melting of the thermoplastic and the mixing of the constituents in the molten thermoplastic are carried out during passage of the material through the extruder. The extrusion is carried out at a temperature between 120° C. and 150° C. The product is extruded in the form of a cylindrical sleeve. At the outlet of the die, the surface of the sleeve, illuminated by a UV lamp, is monitored by camera. The lamp is, more preferably, a lamp emitting UVA rays at low power in a wavelength range in the neighbourhood of 320-400 nanometres, with an intensity peak in the neighbourhood of 370-380 nanometres. The optical brightening agent absorbs radiation in the neighbourhood of 375 nanometres and re-emits between 425 and 450 nanometres.

This monitoring may be provided by an operator or, more preferably, automatically: if the intensity of the luminescent radiation picked up by the camera falls below a certain warning value, the system warns the operator who must quickly check the loading state of the hopper. If this intensity continues to fall, the system stops the manufacturing and the sleeves produced during this anomaly phase are put in with the scraps.

The extruded sleeve described in this example may well be as much a low thickness sleeve used for the construction of skirts and flexible tubes as a thicker sleeve used as a parison in extrusion blow-moulding of bottles.

### Example 3

### Co-Extrusion of a Multilayered Cylindrical Sleeve Whose Inner Layer is Made of Low Density Polyethylene Containing a Bactericide with Tracer

Multilayered co-extruded sleeves are often employed to obtain skirts offering a better barrier to the diffusion of gases and fragrances, for example, by introducing an intermediate layer of EVOH (ethylene-vinyl alcohol copolymer). We proceed as in the extrusion described in example 2, but using several extruders feeding a polymaterial extruding head, by putting the masterbatch of example 1 in the hopper for the material intended to feed the inner layer of the multilayered sleeve.

So that monitoring of the presence of the reactive substance may be easily done, without significant loss of production in the case of detection of an anomaly, it is desirable that the outer layers should be transparent.

If, for example for aesthetic requirements connected with packaging design, a coloured or opaque outer layer is needed, it is possible either to replace the tracer with a tracer which does not bring direct visual monitoring into play (choose, for example, a ferromagnetic charging), or to do the monitoring a little further on, for example in the cutting of the sleeve when the flexible tube skirts with the desired length are produced, the inside of the skirt becoming much more easily accessible visually in this location.

### Example 4

### Extrusion Blow-Moulding of a Polypropylene Bottle Containing a Bactericide with Tracer

The bottle, made entirely of polypropylene, is produced by extrusion blow-moulding of a parison extruded according to the method described in example 2. The masterbatch containing the reactive substance and the tracer is identical to that produced, more preferably with polypropylene, in example 1. The monitoring of the presence of the reactive substance by UV illumination of the outer surface of the bottle is done on the moulded bottle, from the time of the removal of the removable parts of the mould.

### Example 5

### Moulding of a Mono- or Multilayered Tube Head with High Density Polyethylene Containing a Bactericide with Tracer

The head may be moulded by injection or by compression.

If it is moulded by injection, an extruder similar to that used in example 2 is used. The masterbatch containing the reactive substance and the tracer is identical to that produced, more preferably with PEHD, in example 1. The extruder feeds a transfer can with molten plastic material and is then injected into the cavity of the mould.

If it is moulded by compression, an extrudate, massive or hollow, is extruded as in example 4 which, after cutting, becomes a preform that is deposited in the cavity of one of the removable parts of a moulding apparatus, the moulding being carried out by a matching up of the removable parts of the apparatus (see for example patent EP 1 123 241 of the applicant who describes the continuous kinematics manufacturing of flexible tubes by duplicate moulding-compression of the head to the skirt). In the case of moulding by compression, the monitoring of the presence of the tracer, and therefore of the reactive substance, may be carried out before moulding.

Multilayered heads may also be produced by co-injection, as is described in patent EP 1 123 241, by sequential multi-injection or by compression of co-extruded preforms. Several extruders are used, feeding a multiple distribution and/or slide valve transfer can. The masterbatch of example 1 is introduced into the hopper of the material intended to feed the inner layer of the multilayered head.

If the head is overmoulded onto the skirt, i.e. if the fixation of the head to an end of the skirt is carried out by autogenous welding during injection of the head, monitoring of the presence of the reactive substance is facilitated if the outer layers are transparent. In the case in which a coloured outer layer is required, it is possible either to change the tracer (for example, a ferromagnetic charge is chosen), or to do the monitoring a little farther down the production chain, for example, at the time the tube produced in this way is disengaged from its punch-support.

### Example 6

### Deposit of a Varnish Containing a Reactive Substance and a Tracer on the Inner Wall of a Metallic Container

The bactericidal agent cited in example 1 (silver salt in an inert support of zeolith, combined with an oxide of zinc marketed under the name IRGAGUARD (registered trademark) B5000 by the CIBA GEIGY company) is mixed with the tracer (optical brightening agent marketed under the brand-name UVITEX OB (registered trademark) by the CIBA GEIGY company) in the varnish.

For metallic containers such as one-piece aerosol cases made of aluminium alloy, the composition of the varnish and its thickness are chosen as a function of the products and/or propulsion gas contained. In general it concerns epoxy-phenolic compounds, vinyl organosols, polyesters, imide polyamides, etc. The varnish is deposited on the inner wall of the container by a nozzle which enters more or less deeply into the rotating case. The varnish is then dried by thermal treatment or polymerised by UV excitation. More preferably, the temperature of the thermal treatment or of the drying must not exceed 300° C.

For metallic containers such as flexible tubes made of aluminium alloy, the inner surface of the wall of said metallic tube is coated at least partially with a layer of varnish, typically an epoxy, polyurethane, polyester or polyamide resin, comprising the reactive substance and the tracer.

It is also possible to add an oxygen-absorbing reactive substance such as one of the substances described in FR 2 825 689 and a tracer to the resin referred to as “latex-based,” used for the construction of the adhesive joint which is applied in the neighbourhood of the open end of the metallic tube and enables the impermeability of the multiple fold created for the final sealing of the tube after filling with the product to be packaged.

1. A packaging component having a wall comprising a layer for direct contact with a product contained within the packaging, said layer comprising an organic polymer having disposed therein:
1) a first material reactive with at least one component of the product contained within the packaging or with a physical or chemical contaminant thereof, and
2) a second material in the form of physically active particles which perturb or emit, naturally or under the influence of an artificial source of excitation, a physical field which is remotely detectable and which confirms that the first material is also present.

2-17. (canceled)

18. Packaging component as claimed in claim 1, wherein said reactive material is a substance which preserves organoleptic properties of the product.

19. Packaging component as claimed in claim 1, wherein said reactive material is a biocide, a fragrance, a flavor, an oxygen-absorbing agent, a carbon dioxide absorbing agent, a moisture absorbing agent, a UV absorbing agent, an emitter of CO₂, an emitter of SO₂, an emitter of ethanol, an antioxidant or a UV filtering substance.

20. Packaging component as claimed in claim 19, wherein the reactive material is a biocide selected from the group consisting of nitrites, sulfites, organic acids, antimicrobials of natural origin, butylhydroxytoluene (BHT), methyl parahydroxybenzoate, ethyl parahydroxybenzoate, potassium sorbate, benzoic anhydride, sorbic anhydride, sodium benzoate, triclosan (chloro-5-(dichloro-2.4-phenoxy)-2-phenol), quaternary ammonium salts, and salts with metallic ions of silver and/or copper.

21. Packaging component as claimed claim 1, wherein said physically active particles are ferromagnetic.

22. Packaging component as claimed in claim 1, wherein said physically active particles absorb X-rays.

23. Packaging component as claimed in claim 1, wherein said physically active particles are an MRI contrast material.

24. Packaging component as claimed in claim 1 wherein said physically active particles are thermochromic.

25. Packaging component as claimed in claim 1, wherein said physically active particles are luminescent.

26. Packaging component as claimed in claim 25, wherein said physically active particles contain a fluorescent pigment excitable under ultraviolet illumination.

27. Packaging component as claimed in claim 1, comprising a part of a container.

28. Packaging component as claimed in claim 1, comprising a closing means for a container.

29. Packaging component as claimed in claim 1, which is constructed and arranged to be disposed within a container.

30. Packaging component as claimed in claim 29, which is selected from the group consisting of an anti-backflow valve, a net and a flexible screen.

31. Granules of a masterbatch for forming a packaging material for contact with a packaged product, comprising:
a thermoplastic material,
a first material which is a reactive substance for reacting with at least one component of the packaged product or a contaminating agent of said product, and
a second material comprising physically active particles, which second material perturbs or emits, naturally or under the influence of an artificial excitation source, a physical field which can be remotely detected.

32. Granules as claimed in claim 31, wherein the first material is a biocide, a fragrance, a flavor, an oxygen-absorbing agent, a carbon dioxide absorbing agent, a moisture absorbing agent, a UV absorbing agent, an emitter of CO₂, an emitter of SO₂, an emitter of ethanol, an antioxidant or a UV filtering substance.

33. Manufacturing method for a packaging component as claimed in claim 1, wherein said layer comprises a varnish layer, comprising:
mixing the first material and the second material into a varnish, and
depositing the varnish with the first and second materials onto a wall of a packaging component.

34. Manufacturing method for a packaging component as claimed in claim 1, wherein said layer is a layer of thermoplastic material, comprising:
preparing a masterbatch by adding the first material and the second material in pulverulent form to the thermoplastic material in a hopper that feeds an extruder,
extruding the masterbatch in the form of multiple thin filaments,
cutting off said filaments by means of knives to form granules of masterbatch, and
adding the granules of masterbatch to granules of thermoplastic material in a second hopper feeding an extruder used to manufacture the packaging component, either directly or indirectly by creating a preform for blowing, or a block of molten material to produce parts to be molded by injection or compression.
